(19) United States
(12) Patent Application Publication
(10) Pub. No.: US 2023/0382452 A1
(43) Pub. Date: Nov. 30, 2023

(54) MECHANISM FOR INCREASING AUTOMOTIVE GROUND CLEARANCE WITHOUT COMPROMISING FACTORY ALIGNMENT SPECIFICATIONS

(71) Applicants: Varun Prasad, Frisco, TX (US); Bobby Wayne Hale, Bastrop, TX (US)

(72) Inventors: Varun Prasad, Frisco, TX (US); Bobby Wayne Hale, Bastrop, TX (US)

(21) Appl. No.: 18/229,601

(22) Filed: Aug. 2, 2023

Related U.S. Application Data
(60) Provisional application No. 63/346,257, filed on May 26, 2022.

(51) Int. Cl. B62D 7/18

(52) U.S. Cl. CPC B62D 7/18

(57) ABSTRACT

A steering knuckle, comprises a hubseat located below the steering arm mounts. A gearbox to transfer drive from the CV shaft to the vehicle's hub. An access panel held on with screws allows service to the interior side of the steering knuckle and a casing protects the steering knuckle.

### RELATED APPLICATION

The present application claims priority to U.S. Provisional Patent Application Ser. No. 63/346,257, titled “A MECHANISM FOR INCREASING AUTOMOTIVE GROUND CLEARANCE WITHOUT COMPROMISING FACTORY ALIGNMENT SPECIFICATIONS” with Attorney Docket No. PRAL001USP, filed on Jun. 5, 2022, which is fully and completely incorporated by reference herein.

### BACKGROUND OF THE INVENTION

### Field of the Invention

The present invention relates to steering and suspension in pickup trucks which have been modified with an aftermarket ground clearance lift. With currently available designs of steering knuckle, as ground clearance is increased, the steering geometry of a truck is compromised. This can lead to excessive wear on steering and suspension system components.

The object of the present invention is to increase the vertical distance between a vehicle's steering components and the wheel, without placing undue strain on those steering components.

### BRIEF SUMMARY OF THE INVENTION

The invention is a hub-type steering knuckle, arranged such that it provides a mechanism for increasing the ground clearance for automotive vehicles without the loss of factory geometry. Existing designs and methods for translating the action of the steering column to the wheels of lifted vehicles lead to loss of alignment and failure of ball joints.

The invention eliminates the need for increasing the distance between the body and the strut, which is the current practice when effecting an after-market ground clearance lift on a vehicle. Conventional steering knuckle designs have the hubseat centrally located between the steering arm and control arm mounts. The new design takes an alternative approach of moving the hub assembly below the lower control arm.

### BRIEF DESCRIPTION OF THE SEVERAL VIEWS OF THE DRAWINGS

FIG. 1 describes an embodiment of the invention appropriate for a rear-wheel drive vehicle; that is, a vehicle in which the drivetrain's power does not need to be translated through to the hub.

FIG. 2 describes an embodiment of the invention appropriate for an all-wheel drive vehicle, and includes a gearbox which translates drive from the vehicle's constant velocity (CV) shaft down the length of the steering knuckle and through the hub seat.

FIG. 3 shows the invention in context, indicating its relation to the vehicle's upper control arm (UCA) and lower control arm (LCA). It further shows a casing to protect the drive-translation gears as described in FIG. 2.

FIG. 4 shows detail of the LCA mount on the invention, demonstrating a spring-loaded automatic drive tensioner to allow flexibility and movement in the connection with the LCA.

FIG. 5 illustrates the arrangement of the hubseat, steering arm mount, and UCA and LCA mounts in the prior art as compared to the invention. A side view further shows the configuration of the invention, which slopes to allow the drive translation of the all-wheel drive embodiment.

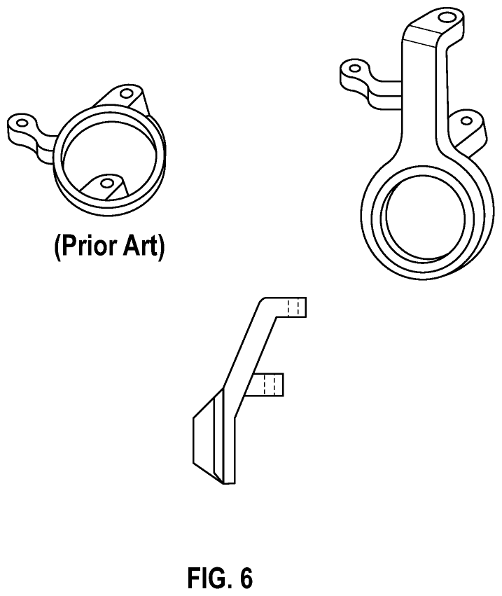

### DETAILED DESCRIPTION OF THE INVENTION

The invention comprises a hub-style steering knuckle oriented in such a way that the ground clearance of automotive vehicles may be increased without the loss of factory geometry. The novel configuration keeps all suspension and powertrain components in their OEM-recommended locations.

The invention moves the hubseat outside of the attachment point to upper control arm (UCA) and lower control arm (LCA) ball joints. Factory steering knuckle designs, as well as conventional lifted knuckle designs, place the hubseat at the center, suspended between the two fixed points.

Conventional lifted suspension designs move the control arms farther apart, then enlarge the steering knuckle proportionally to fit the new space, as to maintain alignability. This design relocates hub assembly from the stock location and relocates it to beneath the LCA, thus maximizing ground clearance and allowing for the installation of larger wheels.

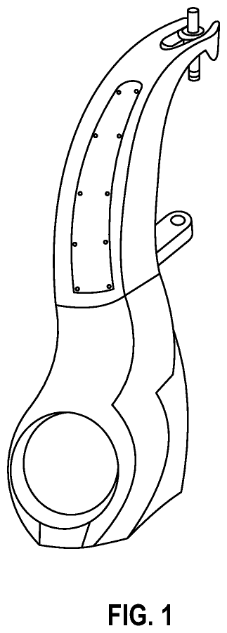

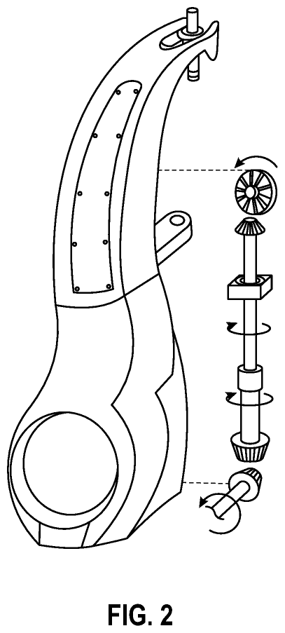

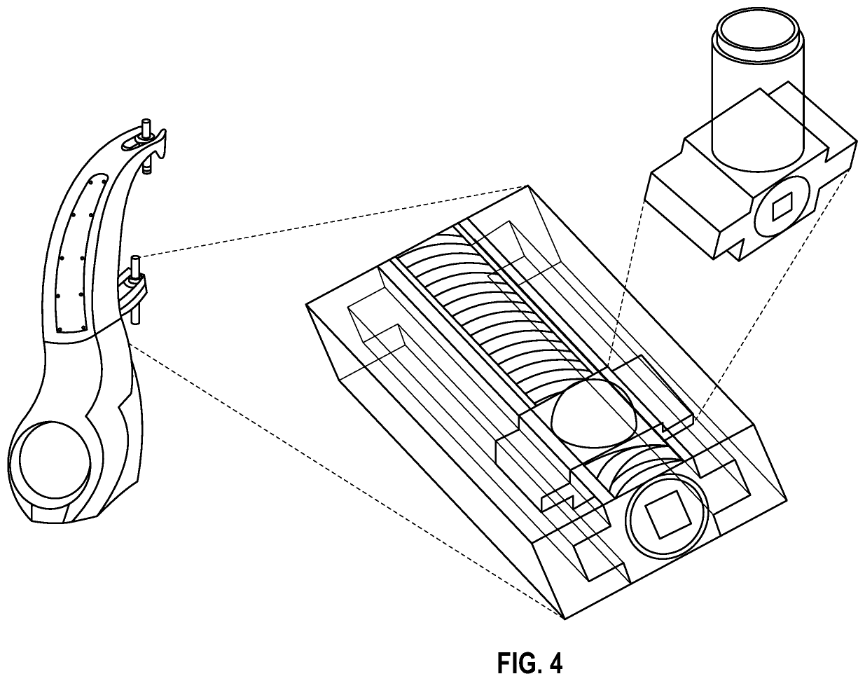

The invention is a machined steel body as shown in FIG. 1. The body is comprised of a hub assembly mount (FIG. 1-4) located below an access panel component (FIG. 1-3), which is further attached to mounts for the steering arm, UCA (FIG. 1-1), and LCA (FIG. 1-2).

Two standing vertical ribs meet at the back of the hub at a 45 degree angle to distribute both vertical and lateral force evenly between the UCA and LCA. The object of the sloping design for the two wheel model is to map the hub from its factory/stock location centered between the upper and lower control arms to a final placement below the LCA, such that ⅓ of the overall wheel is in line with the lower ball joint. The final location of the hub should be out and away from the vehicle. Placing the hub out and down increases ground clearance and guarantees there is no contact with the caliper on the LCA when the knuckle turns right or left. Prior art prevents this caliper contact by placing a “steer strap” on the knuckle, but such a technique causes a reduction in the steering radius.

The invention is conceived in two main embodiments. The first is the hubseat and mount assembly as shown in FIG. 1, and which is appropriate for rear-wheel drive vehicles which do not require the drivetrain's movement to be translated through the steering hub.

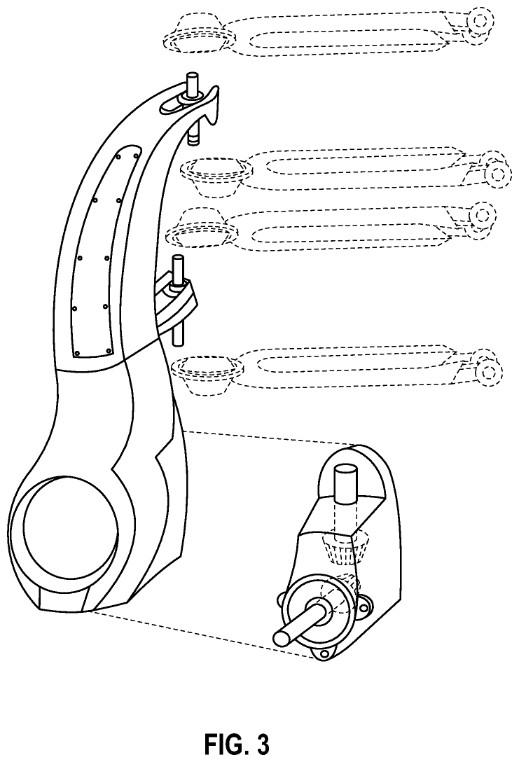

The second embodiment, shown in FIG. 2, is appropriate for all-wheel drive vehicles. This embodiment includes a configuration of gears to translate the rotation of the vehicle's CV shaft down the length of the steering knuckle and out through the hubseat. A protective casing, shown in FIG. 3, houses the gears behind the hubseat.

In all embodiments, a spring-loaded assembly is used as shown in FIG. 3 to allow for flexibility and movement of the vehicle's LCA at its mount point.

Components of the invention include:
a) UCA mount stock tape, maintains factory alignment geometry
b) LCA mount maintains factory specification
c) Steering arm maintains factory specification
d) CV axle drive gear/mount location maintains stock CV angle
e) Drive chain maintains 4×4 capability
f) Spring loaded automatic drive tensioner
g) Caliper mounts

The invention will require an extended brakeline. Factory hub assembly used in 2×4 wheels. 4×4 models come with different hub offset options.

### Concept, Layout, HTB

The concept and layout of patent design is unique because it is the only steering knuckle where the hubseat is located outside of the attachment pipes (upper & lower control arm ball joints). Factory steering knuckle designs, as well as conventional lifted Knuckle designs place the hub seat at the center suspended between the two fixed points.

Conventional lifted suspension design move the control arms farther apart, then enlarge the steering knuckle proportionally to fit the new space, so as to maintain align ability.

This patent design keeps the same distance.

### How to Build—Part 1

The goal of the building process for the two wheel model is to map the hub from its factory/stock location centered between the upper & lower control arms to a final placement of just below the LCA such that ⅓ of the overall wheel is in line with the lower ball joint. The final location of the hub should be out and away from the vehicle. Placing the hub out and down increases ground clearance & guarantees there is no contact with the caliper on the LCA when the knuckle turns right or left. Most manufacturers prevent this caliper contact by placing a “steer strap” on the knuckle, but such a technique causes a reduction in the steering radius.

A 4″ knuckle was used as the starting point to build this prototype. There were two reasons for this 1. The lifted knuckle provides more mass & material with which to work 2. It is overly difficult to expect a fabricator to accurately replicate/obtain the correct dimensions of the depth of the mounting holes & placement of the hub seat in relation to the caliper mount. It is also unrealistic to expect a fabricator to construct accurately a custom hub seat.

To begin, we remove the hub from its factory location centered between the upper & lower control arms. From the 4″ lifted knuckle we remove the LCA mount, the UCA mount & the steering arm. We then use a CNC machine to mill down what remains of our starting point until its no more than a basic mounting plate for the hub and caliper (all the original mounts and features have been removed). The location of what was the original UCA mount becomes the location of the new LCA mount.

### How to Build—Part II

We employ two standing vertical ribs to meet the back of the hub at 45 degrees angles (see FIG. 2a) thus creating a point that distributes both vertical and lateral force evenly between UCA and LCA as if the hub had remained in its factory location. An internal top view of the neck shows the same geometric redundancies as those seen in a trestle bridge.

We continue by cutting two (2) deep channels into the back of the mounting plate for each of the 2 standing ribs (the side plates). Finally, keep notches of the same width as the channels in the plate steel standing ribs are cut into the cast steel hub. We slide the hub along the channel and weld it into place.

### How to Use the Invention

Unscrew the assembly hub, mount the Lift Knuckle under the LCA, mount the assembly hub to fit into the Lift Knuckle.

1. A steering knuckle, comprising a hubseat located below the steering arm mounts.

2. A steering knuckle as in claim 1, further comprising [a gearbox to transfer drive from the CV shaft to the vehicle's hub.

3. A steering knuckle as in claim 1 or 2, with an access panel held on with screws to allow service to the interior side of the steering knuckle.

4. A steering knuckle as in claim 2, with a casing to protect the steering knuckle.
